(19) United States
(12) Patent Application Publication
(10) Pub. No.: US 2003/0121482 A1
(43) Pub. Date: Jul. 3, 2003

(54) One-stroke internal combustion engine

(76) Inventor: Stuart P. Macey, Carlsbad, CA (US)

Correspondence Address: DAIMLERCHRYSLER INTELLECTUAL CAPITAL CORPORATION, CIMS 483-02-19, 800 CHRYSLER DR EAST, AUBURN HILLS, MI, 48326-2757, US

(21) Appl. No.: 10/034,646

(22) Filed: Dec. 28, 2001

(51) Int. Cl. F02B 53/00

(52) U.S. Cl. 123/18 R

(57) ABSTRACT

A single-stroke internal combustion engine is provided and includes a piston block defining a combustion cavity and a compression cavity. A working assembly is operably disposed within the piston block and includes a piston and a compression paddle, each extending radially therefrom. The piston is disposed within the combustion cavity for defining first and second combustion chambers and the compression paddle is disposed within the compression cavity for defining first and second compression chambers. The piston is reciprocally driven between the first and second combustion chambers via a combustion process, whereby the compression paddle concurrently functions to draw in and compress a fuel/air mixture. The piston is operably interconnected to a crankshaft, including a flywheel, for driving the crankshaft.

### FIELD OF THE INVENTION

The present invention relates to internal combustion engines and more particularly to a one-stroke internal combustion engine.

### BACKGROUND OF THE INVENTION

Traditional internal combustion engines (ICEs) come in various configurations, operating through a number cycles. Generally, ICEs operate drawing a fuel/air mixture into a cylinder through an intake valve of a cylinder head. The fuel/air mixture is combusted to drive a piston within the cylinder. The piston is connected to a crankshaft by a connecting rod. The driving force of the piston rotatably drives the crankshaft for propelling a vehicle. The combusted gases within the cylinder head are driven out an exhaust valve of the cylinder head through subsequent piston cycles.

The most common type of ICE is a four-stroke, requiring four strokes of the piston to complete a single combustion process. The strokes include: a first downward stroke for drawing the fuel/air mixture into the cylinder through the intake valve (intake stroke), a first upward stroke for compressing the fuel/air mixture (compression stroke), a second downward stroke providing the driving force after combustion (combustion stroke) and a second upward stroke for pushing the combusted gases out the exhaust valve (exhaust stroke). Thus, for every four-strokes of the piston, only one stroke provides driving force. The remaining strokes of the piston are performed by pushing and pulling the connecting rod, thereby stressing the connecting rod.

An alternative type of ICE is a two-stroke, requiring two strokes of the piston to complete a single combustion process. The strokes include: an upward compression stroke and a downward combustion stroke concurrently exhausting combusted gases and intaking fuel/air mixture. Thus, for every two-strokes of the piston, only one stroke provides a driving force. The remaining stroke of the piston is performed by pushing the connecting rod, thereby stressing the connecting rod.

Multi-stroke ICEs have certain disadvantages. One disadvantage is the inefficiency resulting from the pistons driving the reciprocating mass of one another during the non-driving strokes. In other words, the pistons not only provide a driving force to a drivetrain but also drive the other pistons through their non-driving strokes. Other disadvantages include a relatively low power-to-weight ratio, a larger profile requiring a larger packaging envelope, and the stress on the connecting rods from pushing and pulling action during non-driving strokes.

### SUMMARY OF THE INVENTION

Accordingly, the present invention provides a single-stroke internal combustion engine, including a combustion cavity, a compression cavity, a compression member disposed within the compression cavity for defining first and second compression chambers and a piston in operable communication with the compression member and slidably disposed within the combustion cavity for defining first and second combustion chambers and reciprocating therebetween. Motion of the piston toward the first combustion chamber enables a first fuel/air mixture to flow into the second combustion chamber from the second compression chamber for subsequent combustion. Concurrently, a second fuel/air mixture is drawn into the first compression cavity, whereby motion of the piston toward the second combustion chamber enables the second fuel/air mixture to flow into the first combustion chamber from the first compression chamber for subsequent combustion therein and concurrent drawing of a third fuel/air mixture into the second compression cavity.

The single-stroke internal combustion engine further includes a crankshaft in operable communication with the piston by a connecting rod, whereby the reciprocating motion of the piston causes rotational motion of the crankshaft. A flywheel is preferably disposed about the crankshaft for maintaining proper rotation of the crankshaft through inertial motion.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a driveline implementing a one-stroke internal combustion engine (ICE) in accordance with the principles of the present invention.

FIG. 2 is a plan view of the driveline of FIG. 1;

FIG. 3 is an exploded view of a portion of the one-stroke internal combustion engine of FIG. 1;

FIG. 4 is a cross-sectional view of the one-stroke internal combustion engine along the line 4-4 of FIG. 2;

FIG. 5 is a cross-sectional view of the one-stroke internal combustion engine along the line 5-5 of FIG. 4;

FIG. 6A is a schematic view of the internal combustion engine in a stage 1 rest position;

FIG. 6B is a schematic view of the internal combustion engine in a stage 2 start position;

FIG. 6C is a schematic view of the internal combustion engine in a stage 3 start, fuel/air intake position;

FIG. 6D is a schematic view of the internal combustion engine in a stage 4 start, fuel/air compression position;

FIG. 6E is a schematic view of the internal combustion engine in a stage 5 start, pre-ignition position;

FIG. 6F is a schematic view of the internal combustion engine in a stage 6 pre-ignition, charge position;

FIG. 6G is a schematic view of the internal combustion engine in a stage 7 pre-ignition, fuel/air compression position;

FIG. 6H is a schematic view of the internal combustion engine in a stage 8 combustion position;

FIG. 6I is a schematic view of the internal combustion engine in a stage 9 exhaust position; and

FIG. 6J is a schematic view of the internal combustion engine in a stage 10 combustion position.

### DETAILED DESCRIPTION OF THE PREFERRED EMBODIMENTS

The following description of the preferred embodiments is merely exemplary in nature and is in no way intended to limit the invention, its application, or uses.

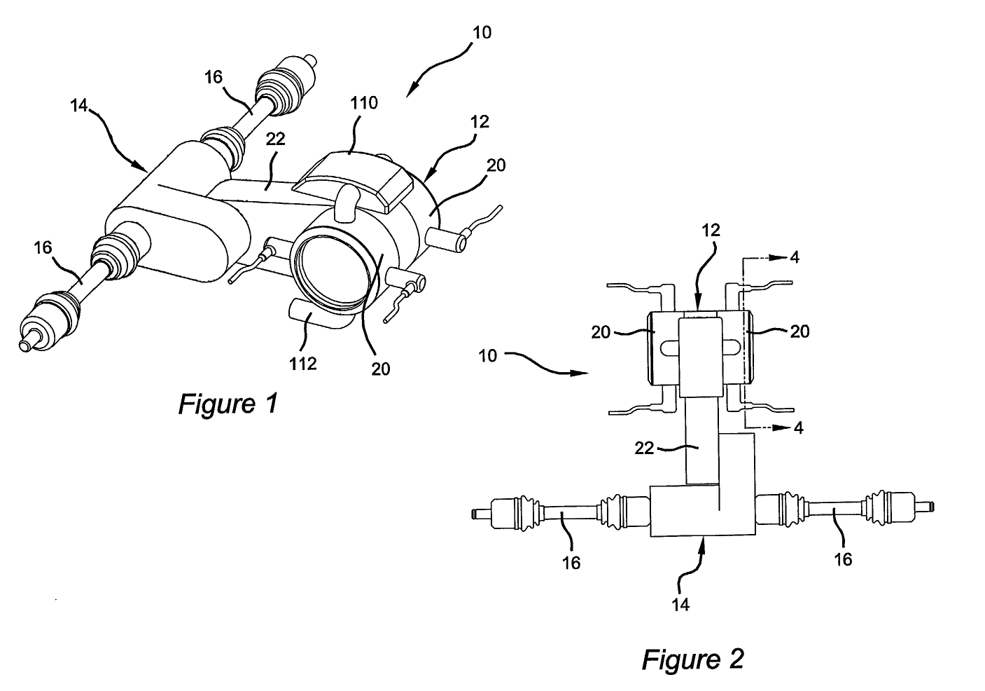

With particular reference to FIGS. 1 and 2, an exemplary driveline 10 is shown including a one-stroke internal combustion engine (ICE) 12, a transmission 14, and a pair of drive shafts 16. The ICE 12 drives the transmission 14, which, in turn, drives the drive shafts 16 through a selectable gear range. The transmission 14 may be one of either an automatic transmission or manual transmission, commonly known in the art. Although the exemplary driveline 10 is shown as that typically implemented for front-wheel drive (FWD) vehicles, it is anticipated that the ICE 12 may be adapted for use with other driveline configurations, including, but not limited to, four-wheel drive (4WD), rear-wheel drive (RWD), and hybrid electric vehicles. It will further be appreciated that the ICE 12 of the present invention is not limited to implementation with vehicular applications, but may also be incorporated as a drive source for any other type of application requiring an ICE. Such applications may include lawnmowers, generators, pumps, snow-blowers and the like.

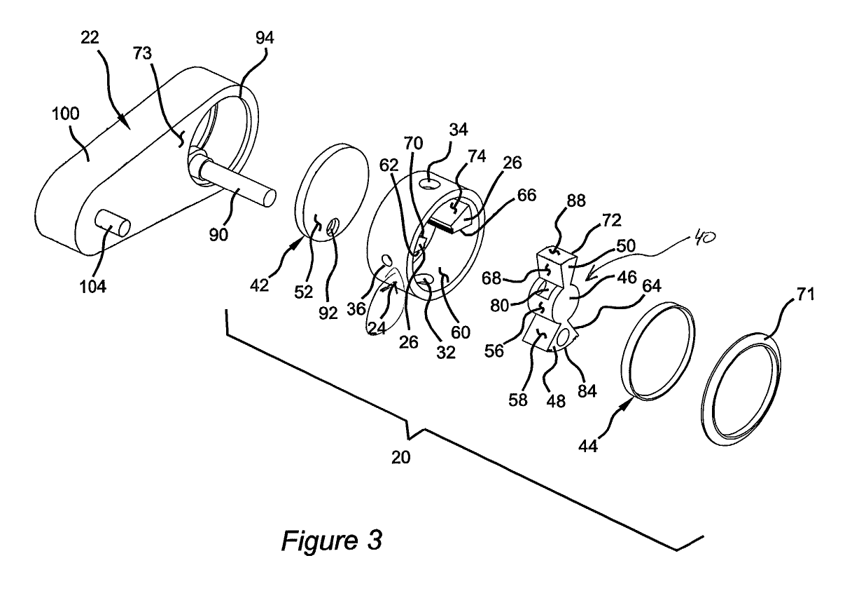

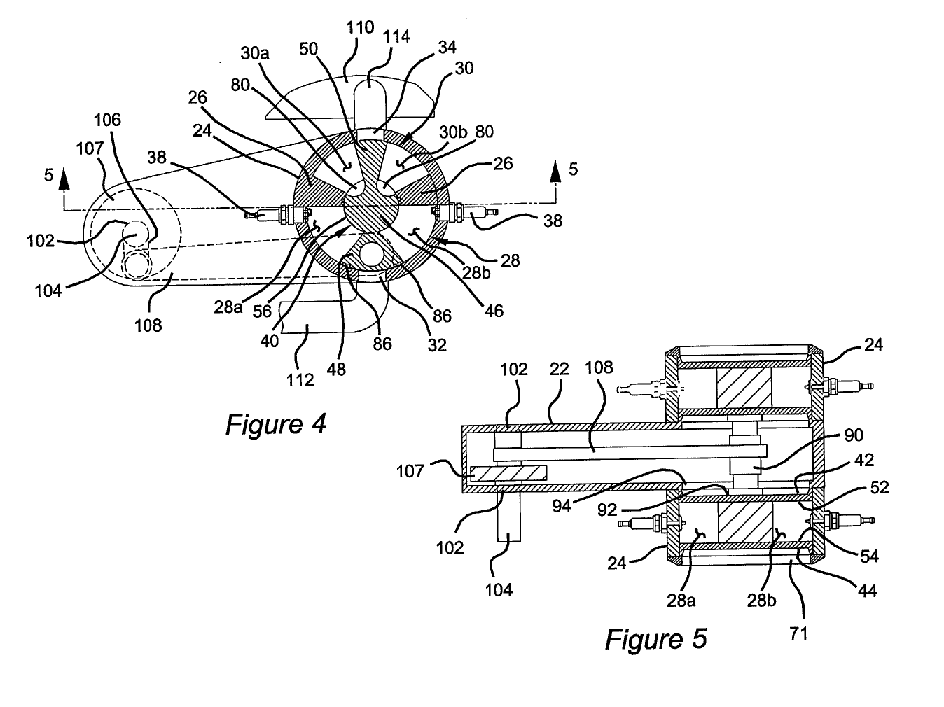

The ICE 12 will be described in detail with reference to FIGS. 2 through 5. The ICE 12 includes first and second piston blocks 20 in mechanical communication with a drive block 22 disposed therebetween, for driving the components of the drive block 22, as described in detail below. The first and second piston blocks 20 are of similar construction and, therefore, the present description will describe only one.

The piston block 20 includes a generally cylindrical block head 24 having a pair of head sections 26 extending radially inward to define an arcuate combustion cavity 28 and an arcuate compression cavity 30. An exhaust port 32 is disposed through the block head 24 for enabling fluid communication from the combustion cavity 28. Similarly, an inlet port 34 is disposed through the block head 24 for enabling fluid communication into the compression cavity 30. Further, a pair of opposing spark plug ports 36 are provided for accommodating a pair of spark plugs 38, as discussed in further detail below.

A working assembly 40 is rotatably disposed within the block head 24 between an internal head wall 42 and an external head wall 44. The internal head wall 42 lies adjacent to the drive block 22, while the external head wall 44 ______. The working assembly 40 includes a cylindrical port section 46, a piston 48, and a compression paddle 50. The piston 48 is disposed within the combustion cavity 28, thereby dividing the combustion cavity into first and second combustion chambers 28a, 28b. Each combustion chamber 28a, 28b includes the spark plug 38 in operable communication therewith through the spark plug ports 36. The compression paddle 50 is disposed within the compression cavity 30, thereby dividing the compression cavity into first and second compression chambers 30a, 30b.

The internal and external head walls 42,44, in conjunction with the working assembly 40 define the first and second combustion chambers 28a,28b and the first and second compression chambers 30a,30b. More particularly, inside surfaces 52,54 of the internal and external walls 42,44, respectively, an outside surface 56 of the port section 46, a sloping surface 58 of the piston 48, an interior surface 60 of the block head 24, and a surface 62 of the head 26 define the first combustion chamber 28a. Similarly, the inside surfaces 52,54 of the internal and external walls 42,44, respectively, the outside surface 56 of the port section 46, a sloping surface 64 of the piston 48, the interior surface 60 of the block head 24, and a surface 66 of the head 26 define the second combustion chamber 28b. The first compression chamber 28a is defined by the inside surfaces 52,54 of the internal and external walls 42,44, respectively, the outside surface 56 of the port section 46, a sloping surface 68 of the compression paddle 50, the interior surface 60 of the block head 24, and a surface 70 of the head 26. Likewise, the second compression chamber 30b is defined by the inside surfaces 52,54 of the internal and external walls 42,44, respectively, the outside surface 56 of the port section 46, a sloping surface 72 of the compression paddle 50, the interior surface 60 of the block head 24, and a surface 74 of the head 26.

The piston block 20 includes an assembly ring 71 to retain the piston block 20 in the assembled position. Specifically, the internal and external walls 42,44 seat within the block head 24, with the heads 26 and working assembly 40 disposed therebetween. The block head 24 is fixed adjacent an external surface 73 of the drive block 22 by the assembly ring 71. A number of methods known in the art may be used to fix the piston block 20 in the assembled position.

A pair of generally semi-circular shaped inlet ports 80 are formed in the port section 46 and selectively enable fluid communication between the combustion cavity 28 and the compression cavity 30, as described further herein. The outside surface 56 of the port section 46 is sealed against and slidably engages the head sections 26 via seals 82. Similarly, an arcuate outer surface 84 of the piston 48 is sealed against and slidably engages the interior surface 60 of the block head 24 via seals 86, and an arcuate outer surface 88 of the compression paddle 50 slidably engages the interior surface 60 of the block head 24.

Through the combustion process, as described in more detail below, the piston 48 follows reciprocal arcuate motion through the combustion cavity 28, inducing pivoting of the working assembly 40 within the piston block 20. The piston 46 is operably interconnected to components of the drive block 22 through the internal head wall 42, whereby the reciprocal motion of the piston 46 drives the components of the drive block 22. More specifically, a drive rod 90 extends perpendicularly from the piston 46 through an aperture 92 of the internal head wall 42 and into the drive block 22 through an opening 94 of the drive block 22. The drive rod 90 operably interconnects the first and second piston blocks 20 for common driving of the components of the drive block 22.

The drive block 22 includes a drive housing 100 having the openings 94 formed in one end thereof and smaller support apertures 102 through an opposing end. The openings 94 enable passage of the drive rod 90 across the interior of the drive block 22. The support apertures 102 rotatably support a crankshaft 104 therebetween. The crankshaft 104 includes a radially extending crank 106 operably attached to a connecting rod 108, which operably interconnects the crankshaft 104 and the drive rod 90. As the connecting rod 108 is driven in reciprocal motion by the pistons 48, the crankshaft 104 is rotatably driven by the crank 106. A flywheel 107 is disposed on the crankshaft 104 for maintaining rotation of the cranskshaft 104 via an inertial force.

An airbox inlet 110 and exhaust outlet 112 are also included for respectively controlling the inlet of fuel and air and the exhaust of combusted gases. The air box inlet 110 includes side ports 114 for providing fluid communication with the intake ports 34 of the piston blocks 20. The exhaust outlet 112 includes exhaust passages for providing fluid communication with the exhaust ports 32 of the piston blocks 20. Although not detailed herein, it is anticipated that the exhaust outlet 112 includes exhaust components commonly known in the art, such as a catalytic converter and a muffler.

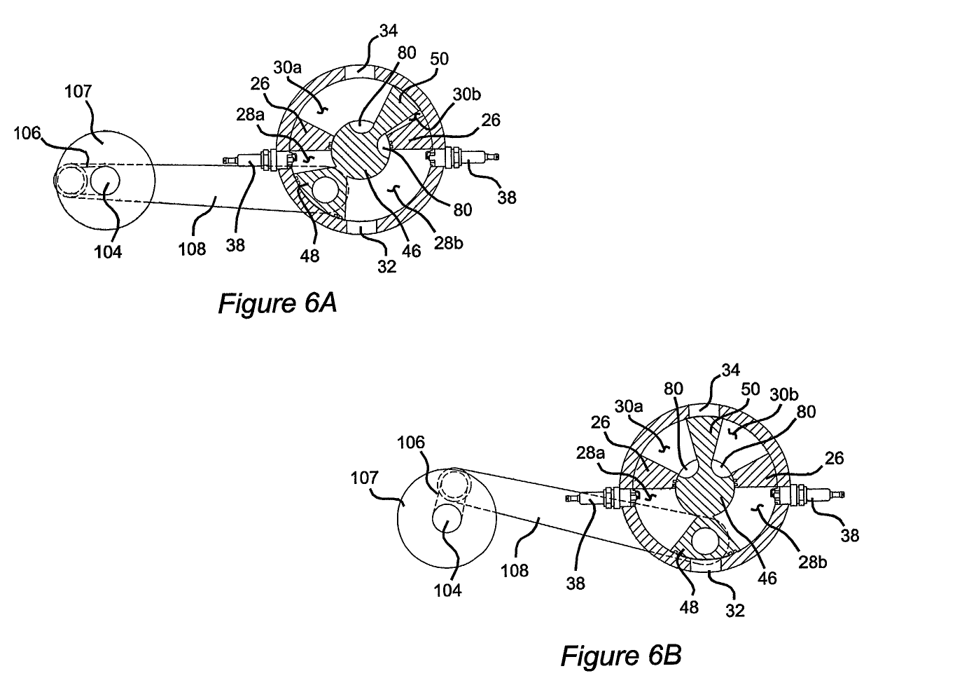

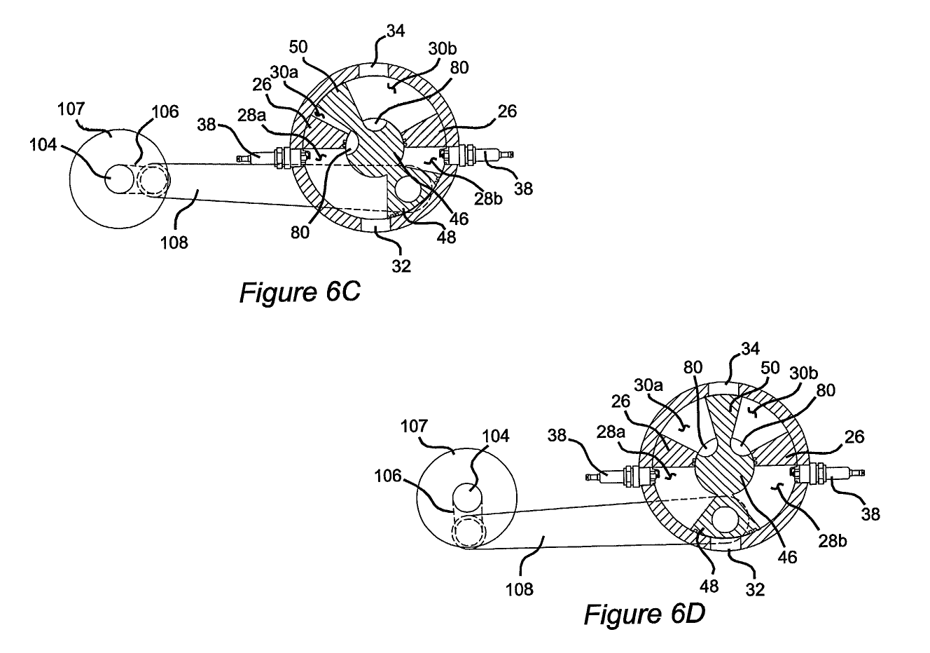

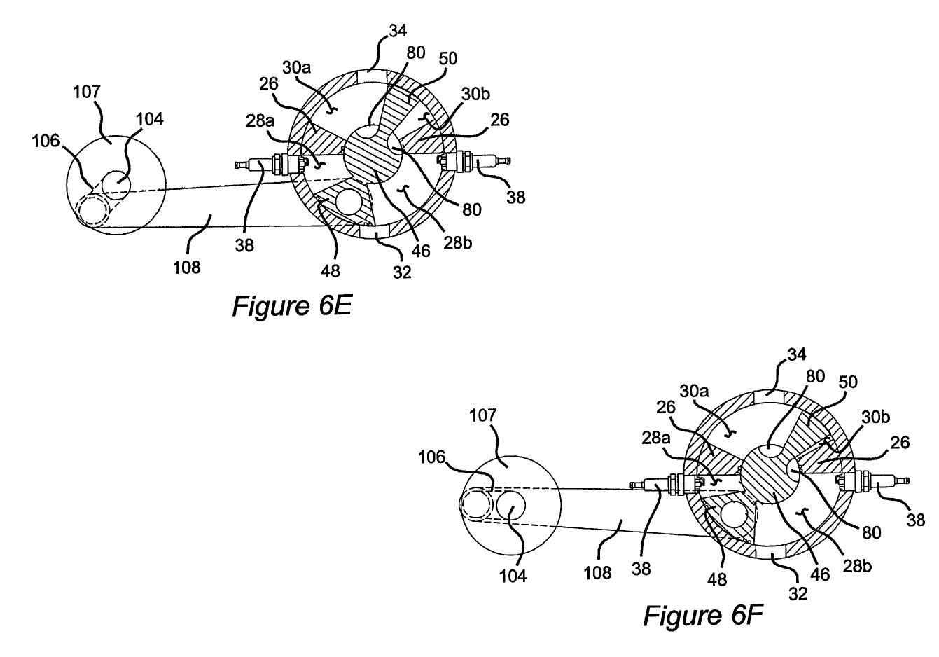

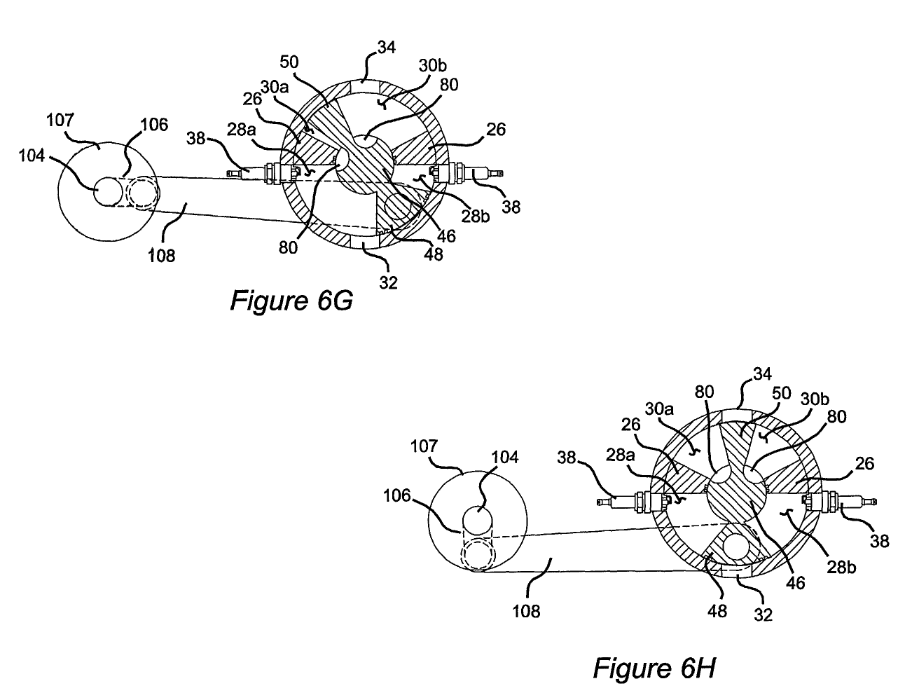

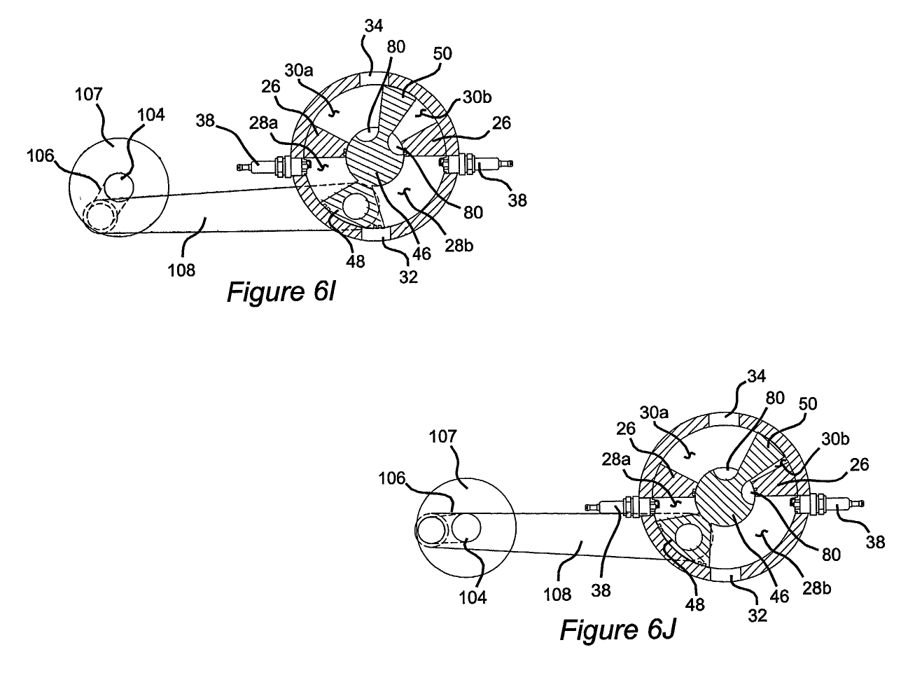

Operation of the ICE 12 will be described with reference to FIGS. 6A through 6J, with each figure detailing a specific operational stage. As seen in FIG. 6, the ICE is in a Stage 1, rest position prior to operation. In the rest position, the piston 48 can be positioned anywhere within the combustion cavity 28. Stages 2 through 7 define a priming sequence (FIGS. 6B through 6G), whereby a starter motor (not shown) induces rotation of the crankshaft 104 for priming the ICE 12. Stages 8 through 10 define a combustion sequence (FIGS. 6H through 6J), whereby the ICE 12 is operating normally.

Stage 2 (FIG. 6B) entails rotation of the crank shaft 104 for driving the piston 48 through the combustion cavity 28, toward a top-dead-center (TDC) position of the first combustion chamber 28a. As the piston 48 drives through the combustion cavity 28, the compression paddle 50 passes the inlet port 34 enabling a fuel/air mixture to be drawn into the first compression chamber 30a via a vacuum force. This action defines Stage 3 (FIG. 6C). During Stage 4 (FIG. 6D), the piston 48 reciprocates toward the second combustion chamber 28b with the compression paddle 50 compressing the fuel/air mixture within the first compression chamber 30a. As the piston 48 reaches the TDC position of the second combustion chamber 28b, the port 80 of the port section 46 bridges the head 26, enabling fluid communication between the first compression chamber 30a and the first combustion chamber 28a. This proceeds during Stages 5 and 6 (FIGS. 6E and 6F, respectively). Concurrently, fuel/air is again being drawn through the inlet port 34 into the second compression chamber 30b by a vacuum force. During Stage 7 (FIG. 6G), the piston 48 moves to the TDC position, compressing the fuel/air mixture within the first combustion chamber 28a. Concurrently, the fuel/air mixture within the second compression chamber 30b is compressed and flows into the second combustion chamber 28b through the port 80 and a fuel/air mixture is drawn into the first compression chamber 30a through the inlet port 34.

Once in the TDC position, the compressed fuel/air mixture is ignited within the first combustion chamber 28a by the spark plug 38. This occurs during Stage 8 (FIG. 6H), forcing the piston 48 to reciprocate towards the second combustion chamber 28b, subsequently compressing the fuel/air mixture in the second combustion chamber 28b in Stage 9 (FIG. 61) and compressing the fuel/air mixture in the first compression chamber 30a. As the piston 48 passes the exhaust port 32, the combusted gases in the first combustion chamber 28a are forced therethrough by the pressure within the first combustion chamber 28a. Further, a fuel/air mixture is again drawn into the second compression chamber 30b through the inlet port 34. At Stage 10 (FIG. 6J), the piston 48 achieves the TDC position in the second combustion chamber 28b side, compressing the fuel/air mixture therewithin for combustion to drive the piston 48 back toward the first combustion chamber 28a with the combusted gases exhausting from the second combustion chamber 28b out the exhaust port 32. Stages 8 through 10 are continuously repeated during normal operation of the ICE 12 for rotatably driving the crankshaft 104. Operating in this manner, fuel/air intake and combusted gas exhaust occurs at approximately each 45° of rotation of the working assembly 40. Further, combustion occurs at every 180°, thereby providing a single-stroke configuration, combusting twice as many times as a two-stroke ICE and four times as many as a four-stroke ICE, thereby providing a relatively higher power output.

The ICE 12, as described herein retains specific advantages over traditional ICEs. A significant advantage is a greater power to weight ratio. Thus, a smaller ICE can be implemented for achieving an equivalent power output, providing a lower profile for improving packaging and crash-performance within a vehicle application. A relatively lighter ICE is also provided through reduced component count. Specifically, fewer connecting rods are required, as well as the elimination of a valve train for controlling the intake and exhaust. Further, the ICE 12 of the present invention is more efficient than traditional ICEs in that there is a significantly reduced reciprocating mass.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A single-stroke internal combustion engine, comprising:
a combustion cavity;
a compression cavity;
a compression member disposed within said compression cavity for defining first and second compression chambers; and
a piston in operable communication with said compression member and slidably disposed within said combustion cavity for defining first and second combustion chambers and reciprocating therebetween, whereby motion of said piston toward said first combustion chamber enables a first fuel/air mixture to flow into said second combustion chamber from said second compression chamber for subsequent combustion therein and concurrent drawing of a second fuel/air mixture into said first compression cavity, whereby motion of said piston toward said second combustion chamber enables said second fuel/air mixture to flow into said first combustion chamber from said first compression chamber for subsequent combustion therein and concurrent drawing of a third fuel/air mixture into said second compression.

2. The single-stroke internal combustion engine of claim 1, further comprising an inlet port for enabling fluid communication of said fuel/air mixtures into said compression cavity.

3. The single-stroke internal combustion engine of claim 1, further comprising an exhaust port for enabling exhausting of combusted gases from said combustion cavity.

4. The single-stroke internal combustion engine of claim 1, further comprising a port section disposed between said compression and combustion cavities and in operable communication with said piston and said compression member, said port section selectively enabling fluid communication between said compression and combustion cavities.

5. The single-stroke internal combustion engine of claim 4, wherein said port section includes first and second ports formed therein, selectively bridging said compression and combustion cavities for providing fluid communication therebetween.

6. The single-stroke internal combustion engine of claim 1, further comprising first and second spark plugs respectively in operable communication with said first and second combustion chambers for enabling combustion of said fuel/air mixtures therein.

7. The single-stroke internal combustion engine of claim 1, further comprising a crankshaft in operable communication with said piston, whereby said reciprocating of said piston induces rotational motion of said crankshaft.

8. The single-stroke internal combustion engine of claim 7, further comprising a connecting rod for operably interconnecting said crankshaft and said piston.

9. The single-stroke internal combustion engine of claim 7, further comprising a flywheel disposed about said crankshaft.

10. An internal combustion engine, comprising:
an engine block defining a combustion cavity and a compression cavity; and
a working assembly rotatably supported within said cylindrical cavity, comprising:
a central port portion;
a compression member extending from said central port portion into said fuel processing cavity for defining first and second fuel compression chambers on either side;
a piston extending from said central port portion into said combustion cavity for defining first and second combustion chambers on either side thereof;
said piston reciprocating within said combustion cavity, wherein motion of said piston toward said first combustion chamber enables a first fuel/air mixture to flow into said second combustion chamber from said second compression chamber for subsequent combustion therein and concurrent drawing of a second fuel/air mixture into said first compression cavity, whereby motion of said piston toward said second combustion chamber enables said second fuel/air mixture to flow into said first combustion chamber from said first compression chamber for subsequent combustion therein and concurrent drawing of a third fuel/air mixture into said second compression.

11. The internal combustion engine of claim 10, further comprising an inlet port for enabling fluid communication of said fuel/air mixtures into said compression cavity.

12. The internal combustion engine of claim 10, further comprising an exhaust port for enabling exhausting of combusted gases from said combustion cavity.

13. The internal combustion engine of claim 10, wherein said central port section includes first and second ports formed therein, selectively bridging said compression and combustion cavities for providing fluid communication therebetween.

14. The internal combustion engine of claim 10, further comprising first and second spark plugs respectively in operable communication with said first and second combustion chambers for enabling combustion of said fuel/air mixtures therein.

15. The internal combustion engine of claim 1, further comprising a crankshaft in operable communication with said piston, whereby said reciprocating of said piston induces rotational motion of said crankshaft.

16. The internal combustion engine of claim 15, further comprising a connecting rod for operably interconnecting said crankshaft and said piston.

17. The internal combustion engine of claim 15, further comprising a flywheel disposed about said crankshaft.
